(19) United States
(12) Patent Application Publication
(10) Pub. No.: US 2014/0250783 A1
(43) Pub. Date: Sep. 11, 2014

(54) BIODEGRADABLE PLANT CONTAINER

(71) Applicant: Chris Keller, Effingham, IL (US)

(72) Inventor: Chris Keller, Effingham, IL (US)

(21) Appl. No.: 13/790,583

(22) Filed: Mar. 8, 2013

(51) Int. Cl. A01G 9/10; B65D 25/00

(52) U.S. Cl. CPC A01G 9/102; B65D 25/00
USPC 47/74; 264/258; 206/524.6

(57) ABSTRACT

A biodegradable container including a base, at least one sidewall extending from the base and comprising an inner surface and an opposite outer surface, at least a portion of the base and the at least one side wall is formed from seaweed, and a biodegradable polymer coating applied to at least a portion of the base and the at least one sidewall.

### BACKGROUND OF THE INVENTION

The field of the invention relates generally to containers used to grow plants, and more particularly, to biodegradable plant containers.

Generally, biodegradable plant containers are containers that can be used to transport plants and to grow plants. When the plants are ready for propagation in a more permanent setting, the container is placed in soil and the plant roots grow through the container as the container degrades in the soil. Although such containers generally allow some plants to be initially rooted and transported to a permanent location, the use of such containers may be limited. For example, at least some known biodegradable plant containers are so porous that they do not adequately retain liquid and as such, require constant watering to sustain the plant. Other known biodegradable plant containers configured to retain water within the container, but are fabricated from materials that make it difficult for a plant inside the container to achieve root penetration through the container. Furthermore, other known biodegradable plant containers are fabricated from materials that are so weak that it makes transporting plants difficult without damaging the container.

### BRIEF DESCRIPTION OF THE INVENTION

A biodegradable container is provided. The biodegradable container including a base, at least one sidewall extending from the base and comprising an inner surface and an opposite outer surface, at least a portion of the base and the at least one side wall is formed from seaweed, and a biodegradable polymer coating applied to at least a portion of the base and the at least one sidewall.

A biodegradable container system for use with plants is provided. The biodegradable container system includes a container and a water retention trap. The container and water retention trap each include a base, at least one sidewall extending from the base and comprising an inner surface and an opposite outer surface, at least a portion of the base and the at least one side wall is formed from seaweed, and a biodegradable polymer coating applied to at least a portion of the base and the at least one sidewall

A method of fabricating a plant container is provided. The method including molding seaweed into a container that includes at least a base and at least one sidewall, and applying a biodegradable polymer coating to the base and to the at least one sidewall.

### BRIEF DESCRIPTION OF THE DRAWINGS

FIG. 1 is a schematic illustration of an exemplary container that may be used to grow plants.

FIG. 2 is a bottom schematic view of the container shown in FIG. 1.

FIG. 3 is a flowchart of an exemplary method that may be implemented to produce the container shown in FIG. 1.

### DETAILED DESCRIPTION OF THE INVENTION

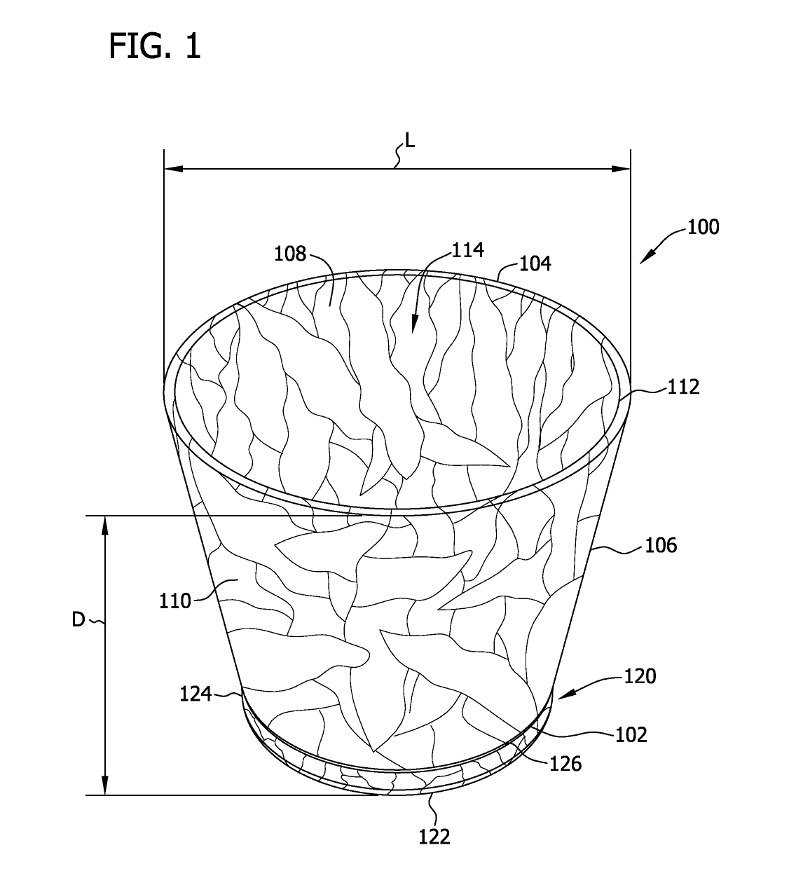

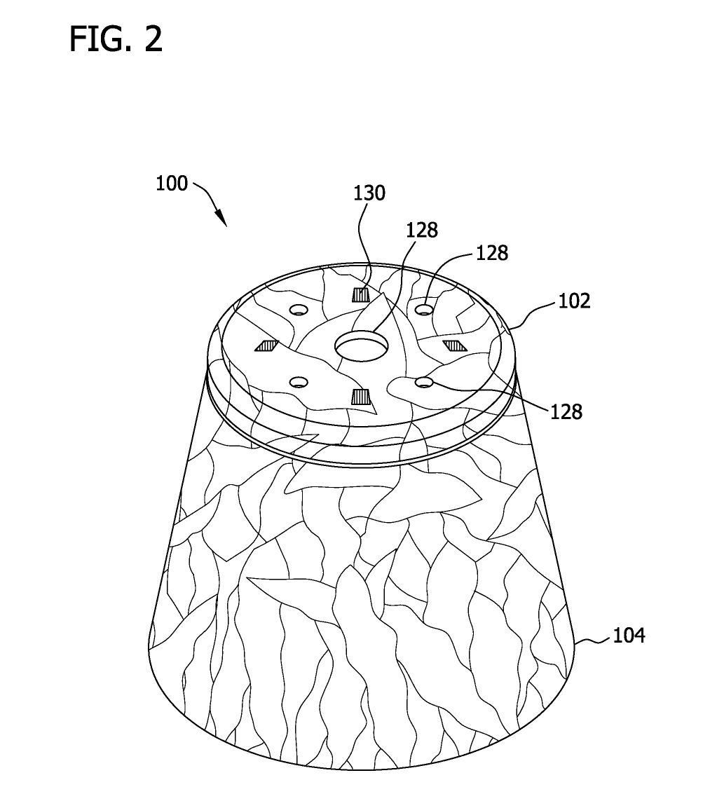

FIGS. 1 and 2 are schematic illustrations of an exemplary container 100 that may be used to grow a plant. In the exemplary embodiment, container 100 includes a base 102, an upper edge 104, and sidewalls 106. More specifically, in the exemplary embodiment, sidewalls 106 extend from base 102 to upper edge 104. Moreover, in the exemplary embodiment, base 102 is substantially circular. Alternatively, base 102 may be formed in any shape that enables container 100 to function as described herein such as, but not limited to, rectangular, elliptical, substantially square, triangular, octagonal, and/or hexagonal.

In the exemplary embodiment, sidewalls 106 include an inner surface 108 and an outer surface 110. An aperture 112 is defined by and circumscribed by upper edge 104 such that a cavity 114 is formed within container 100 for receiving a plant to be grown and any materials necessary to aid in the growth of the plant, such as soil, fertilizer, and/or nutrients, for example. Cavity 114 is defined by base 102, inner surface 108 and upper edge 104. In the exemplary embodiment, sidewalls 106 taper downwardly and radially inwardly towards a center of base 102. Alternatively, sidewalls 106 may be substantially perpendicular and/or have any relative orientation to base 102 that enables container 100 to function as described herein. In the exemplary embodiment, sidewalls 106 have a thickness of about 3 millimeters. Thickness T is measured between sidewall inner and outer surfaces 108 and 110, respectively. Alternatively, sidewalls 106 can have any thickness that enables container 100 to function as described herein.

In one embodiment, a water retention trap 120 is positioned in close proximity to container 100 to facilitate retaining excess liquid seeping from container 100. For example, in one embodiment, trap 120 may be coupled to container base 102. Water retention trap 120, in the exemplary embodiment, is formed with a base 122, sidewalls 124, and an upper edge 126. Moreover, in the exemplary embodiment, container 100 is formed with at least one aperture 128 in a sidewall 106 and/or in base 102 that enables fluids to seep from container 100 into trap 120. More specifically, aperture 128 facilitates preventing excess fluids from building up along container base 102. Container 100 may be formed with any number apertures 128 that enables container 100 to function as described herein. In one embodiment, liquid release apertures 128 are sized and oriented to receive a protrusion 130 extending upwardly from base 122 of water retention trap 120 to facilitate securing water retention trap 120 to container 100. In one embodiment, protrusions 130 enable trap 120 to be coupled against container base 102. In the exemplary embodiment, base 102 includes protrusions 130 that extend outward from a lower surface of base 102 to ensure that water retention trap 120 remains a distance from container 100 when trap 120 is coupled to container 100. Maintaining a distance of separation between container 100 and trap 120 creates a trough sized to receive fluid discharged from apertures 128.

In the exemplary embodiment, container 100 is formed with a depth D that is variably selected depending on the plant to be grown within container 100. Container 100 may be sized to hold a predefined volume, such as, but not limited to, one gallon, two gallons, and/or three gallons. Container 100 can be manufactured to have any volumetric size that enables it to function as described herein.

In the exemplary embodiment, water retention trap 120 and/or container 100, including all components such as base 102 and sidewalls 106 are fabricated from seaweed. As used herein, the term seaweed refers to any benthic marine algae, including but not limited to, red, green, and/or brown algae. Alternatively, container 100 and water retention trap 120 can be manufactured from any form of seaweed. In the exemplary embodiment, container 100 and water retention trap 120 are also formed using kelp. In an alternative embodiment, container 100 and water retention trap 120 are formed using materials that enable container 100 to be formed with a desired strength, porosity, and/or biodegradability. In another embodiment, container 100 is fabricated from a different material or combination of materials than trap 120. Moreover, in another embodiment, at least one portion, such as sidewalls 106 and/or 124 of container 100 and/or trap 120 is fabricated from a different material than remaining portions of container 100 and/or trap 120.

In the exemplary embodiment, at least one of water retention trap 120 and/or container 100 is coated with a biodegradable polymer. For example, in one embodiment, a biodegradable thermoplastic polyurethane is applied over at least a portion of container 100 and/or retention trap 120. In another embodiment, at least a portion of container 100 and/or trap 120 is coated with the biodegradable thermoplastic polyurethane. In one embodiment, at least a portion of container 100 and/or water retention trap 120 is coated with a biodegradable polymer having a thickness of about 0.5 millimeters to about 2 millimeters. Alternatively, the polymer coating can have any thickness that enables container 100 to function as described herein. The biodegradable polymer facilitates the retention of liquid within container 100 and/or trap 120 while providing container 100 and/or trap 120 to enhance structural integrity. The use of the biodegradable polymer also increases shelf life and facilitates enhancing the durability of container 100 and/or trap 120 without impeding the ability of a growing plant's roots to penetrate container 100.

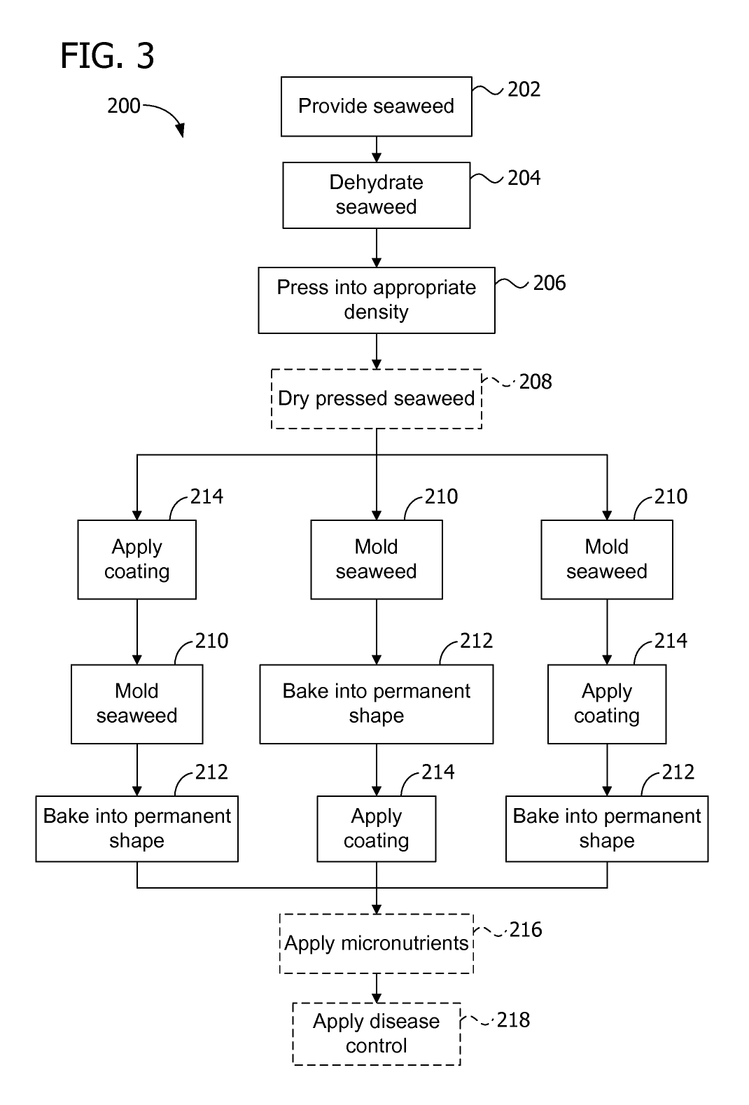

FIG. 3 is a flowchart of an exemplary method 200 that may be implemented to a container for use in growing plants, such as, produce container 100 shown in FIG. 1. In the exemplary embodiment, initially a supply of seaweed is dehydrated 204 to facilitate removing excess moisture from the seaweed. More specifically, in the exemplary embodiment, seaweed is dehydrated 204 at a controlled and relatively low temperature for a predefined time period. Alternatively, dehydration 204 may occur in any manner that removes substantially all moisture from the seaweed. Sheets (not shown) of seaweed are then pressed 206 together to form layers. In one embodiment, at least 2 sheets are compressed together to form a layer of seaweed. A plurality of seaweed layers are then pressed 206 together to form a seaweed wall having a predefined density, diameter, and/or thickness for use in forming each container 100. For example, in one embodiment, layers are formed having a thickness of between about 0.5 millimeters to about 3 millimeters. After pressing 206 seaweed into layers, the layers are also dried 208 to remove additional moisture therefrom.

In the exemplary embodiment, the dried layers are molded 210 into a desired shape, such as container 100 and/or water retention trap 120 (each shown in FIG. 1). In one embodiment, the dried layers are formed about a mold and steam is selectively applied to enhance the flexibility and pliability of layers during the fabrication process. A plurality of layers can be applied about the same mold to enable the object being formed, i.e., container 100 and/or trap 120, to be formed with a desired thickness in specific regions throughout. Alternatively, the layers can be molded 210 in any manner and/or using any process that enables a container 100 and/or trap 120 to be formed as described herein.

In the exemplary embodiment, the molded 210 layers are baked 212 to ensure the layers remain in permanent and predefined shape. For example, one embodiment, the molded 210 layers are baked at a temperature of between about 200° Fahrenheit to about 500° Fahrenheit for about 8 to 12 minutes. Baking 212 the molded 210 layers, not only sets the layers in a permanent shape, but also facilitates removing any excess moisture that may have been imparted to the layers during the molding 210 process. Alternatively, baking 212 can occur in any manner that enables the fabrication of container 100 and/or trap 120 as described herein.

In the exemplary embodiment, a biodegradable polymer is applied 214 to the baked 212 assembly. As described above, the biodegradable polymer provides structural support to the layers and facilitates fluid retention within container 100 and/or trap 120. In one embodiment, the baked assembly is dipped in a biodegradable thermoplastic polyurethane to ensure that a coating is applied 214 to all portions of the layers. Alternatively, the biodegradable polymer may be painted or sprayed on any portion of the baked assembly. In the exemplary embodiment, the biodegradable thermoplastic polymer is applied 214 with a predetermined thickness. The use of the biodegradable polymer also increases shelf life and facilitates enhancing the durability of container 100 and/or trap 120 without impeding the ability of a growing plant's roots to penetrate container 100.

Alternatively, the biodegradable polymer can be applied 214 at any time during the fabrication process 200. For example, the biodegradable polymer can be applied 214 after molding 210 the seaweed into a desired shape and before the layers are baked 212.

In one embodiment, micronutrients are applied 216 across a portion, such as, inner surface 108 of sidewalls 106 and/or across a portion of base 102. The micronutrients are applied 216 to enhance the ability of a plant to grow within container 100. More specifically, the micronutrients are releasably coupled such that when the growing plant and potting materials are placed in container 100 the micronutrients can mix with the potting materials when contacted by water. In one embodiment, the micronutrients include auxins that facilitate increasing rooting capabilities of a plant within container 100. Alternatively, any other micronutrients may be applied to the layers.

In the exemplary embodiment, a disease control coating is also applied 218 to at least a portion of the container assembly. The disease control coating can include any application that facilitates preventing or eliminating plant diseases including, but not limited to, fungicides, bactericides, and insecticides. In the exemplary embodiment, an antifungal agent is applied 218 to the container assembly.

The above described container system provides a container system for use in growing plants that is cost-effective and environmentally friendly. Additionally, the container system provides a moisture retentive container for propagation that retains its shape from shelf to planting and completely biodegrades. Because the container system is moisture retentive, the growing plant requires less water and provides water conservation because the appropriate soil moisture content necessary for rooting would be easily maintained. The use of seaweed in the process is beneficial as there is no chemical change required in the creation of the base substance of the container and thus creates no chemical waste with which to dispose of.

An added benefit of the above described container is that water alone does not breakdown the container and natural chemical or biological activity present in soil is necessary to decompose the container and allow for structural decomposition. Also, there is no need for a surfactant like glue to maintain its shape as is found in known plant pots.

This written description uses examples to disclose the invention, including the best mode, and also to enable any person skilled in the art to practice the invention, including making and using any devices or systems and performing any incorporated methods. As such, the use of “container” and “container system” are used interchangeably and utilized by way of example to describe container 100, water retention trap 120, and the combination of container 100 and water retention trap 120. Also the term “growing plant” or “plant” can refer to any living organisms belonging to the kingdom Plantae including seeds or ripened ovules of plants. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A biodegradable container comprising:
a base;
at least one sidewall extending from said base and comprising an inner surface and an opposite outer surface, at least a portion of said base and said at least one side wall is formed from seaweed; and
a biodegradable polymer coating applied to at least a portion of said base and said at least one sidewall.

2. The container of claim 1, wherein said biodegradable polymer coating is a biodegradable thermoplastic polyurethane.

3. The container of claim 1, further comprising a disease control coating applied to at least a portion of said at least one sidewall.

4. The container of claim 1, further comprising micronutrients applied to at least a portion of at least one of said base and said inner surface.

5. The container of claim 1, wherein said at least one sidewall extends obliquely from said base.

6. The container of claim 1, wherein said base is shaped to be at least one of rectangular, oval, square, triangular, octagonal, and hexagonal.

7. A biodegradable container system for use with plants, said container system comprising:
a container and a water retention trap, the container and water retention trap each comprising:
a base;
at least one sidewall extending from said base and comprising an inner surface and an opposite outer surface, at least a portion of said base and said at least one side wall is formed from seaweed
a biodegradable polymer coating applied to at least a portion of said base and said at least one sidewall.

8. The container system of claim 7, wherein said water retention trap includes at least one projection extending from said base and wherein container said base includes at least one aperture sized and oriented to receive said at least one projection of said water retention trap.

9. The container system of claim 7, wherein said container includes at least one projection extending from said base and wherein said water retention trap includes at least one aperture sized and oriented to receive said at least one projection of said container.

10. The container system of claim 7, wherein said biodegradable polymer coating is a biodegradable thermoplastic polyurethane.

11. The container system of claim 7, further comprising a disease control coating applied to at least a portion of said at least one sidewall.

12. The container system of claim 7, further comprising micronutrients applied to at least a portion of at least one of said base and said inner surface.

13. The container system of claim 7, wherein said base of said container is shaped to be at least one of rectangular, oval, square, triangular, octagonal, and hexagonal

14. The container system of claim 7, wherein said at least one sidewall extends obliquely from said base.

15. A method of fabricating a plant container, said method comprising:
molding seaweed into a container that includes at least a base and at least one sidewall; and
applying a biodegradable polymer coating to the base and to the at least one sidewall.

16. The method of claim 15, further comprising pressing layers seaweed together into layers having a predetermined density.

17. The method of claim 15, further comprising heating the layers of the growing plant container such that the layers are formed into a permanent shape.

18. The method of claim 15, further comprising applying micronutrients to the at least one sidewall of the container.

19. The method of claim 15, further comprising applying a disease control coating to the container.

20. The method of claim 15, wherein molding the seaweed into a container further comprises molding the seaweed into a container using at least one of steam and gas and a mold, wherein the seaweed is formed about the mold.
